(19) United States
(12) Patent Application Publication
(10) Pub. No.: US 2002/0106489 A1
(43) Pub. Date: Aug. 8, 2002

(54) Structure of a board-like frame

(76) Inventor: Kuo Yen Lai, Taipei (TW)

Correspondence Address: LAI Kuo Yen, PO Box 82-144, Taipei, TW

(21) Appl. No.: 09/777,826

(22) Filed: Feb. 7, 2001

(51) Int. Cl. B32B 3/30

(52) U.S. Cl. 428/167; 428/99

(57) ABSTRACT

A structure of a board-like frame comprising a board body having a board surface being provided with a plurality of recessed grooves. By folding along the recessed groove, the board body can form into sealed frame having a circular-shaped cross section, a rectangular cross-section, or a polygonal cross-section, and alternatively the board body can be folded into a “C”-shaped or “L”-shaped opened frame structure.

### BACKGROWND OF THE INVENTION

1. Field of Invention

The present invention relates to a raw material having the structure of a board-like frame, and in particular to a frame structure of a flat board surface which can be folded to form into the required shaped structure.

2. Brief Description of the Prior Art

For interior decoration a plurality of frames are used to form a framework structure and a board surface is then placed on the top of the structure to form, for instance, an extended table top, a cupboard, a wall surface, and the like. The conventional frame structure is normally formed integrally from steel material or plastic material. As the framework is made of rigid material, the shape of the framework cannot be changed and therefore a plurality of frames have to be made for various types of application. Thus, the cost of manufacturing the frame is increased and the manufacturers have great problems in handling these framework structures.

In addition, such a rigid framework generally has a hollow polygonal shaped, “L”-shaped or arch-shaped cross-section thereby occupying a large space and making two frames unable to be closely positioned together. As a result, the storage of this structure takes a greater space and it causes problems in transportation. Thus, it is an object of the present invention to provide a structure of a board-like frame to mitigate the above drawbacks.

### SUMMERY OF THE INVENTION

Accordingly, an object the present invention is to provide a structure of a board-like frame comprising a board body having a board surface being provided with a plurality of recessed grooves. By folding along the groove, the board body can form into sealed frame having a circular shaped cross-section, a rectangular cross-section, or a polygonal-shaped cross-section, and alternatively, the board body can be folded into a “C”-shaped, or “L” shaped opened frame structure.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principle of the present invention is shown by way of illustrative example.

### BRIEF DESCRIPTION OF THE DRAWINGS

FIG. 1 is a perspective view of the present invention.

FIG. 2 is a top view for the structure of the present invention.

FIG. 3 is a schematic view taken along line 3-3 of FIG. 2 of the present invention.

FIG. 4 is a sectional view taken along line 44 of FIG. 2 of the present invention.

FIG. 5 is a schematic view of the board body prior to forming a through positioning hole.

FIG. 6 is a perspective view of the present invention in a roll-shaped.

FIG. 7 is a perspective view of the frame structure, showing a rectangular shaped sealed cross-section of the board body of FIG. 1.

FIG. 8 is a sectional view taken along line 8-8 of FIG. 7 of the present invention.

FIG. 9 is a schematic view of I-shaped frame structure forming from the board body of FIG. 1 of the present invention.

FIG. 10 is a sectional view taken along line 10-10 of FIG. 9 in accordance with the present invention.

FIG. 11 is a perspective view of the frame in accordance with the present invention.

FIG. 12 is a sectional view along line 12-12 of FIG. 11 of the present invention.

FIG. 13 is a schematic view of another preferred embodiment of the present invention.

FIG. 14 is a schematic view showing various cross-sectional shape of the present invention.

FIG. 15 is a schematic view of the frame of the present invention.

FIG. 16 is a schematic view of another preferred embodiment.

FIG. 17 is a schematic view of another preferred embodiment.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

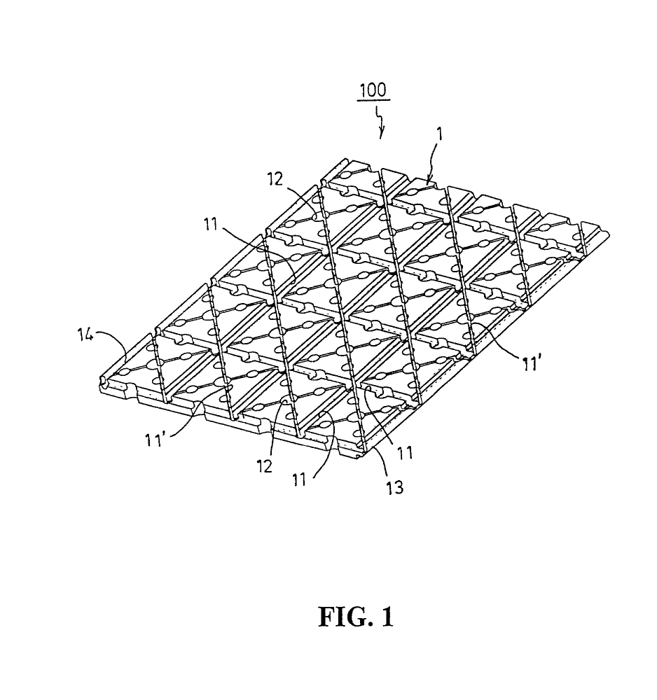

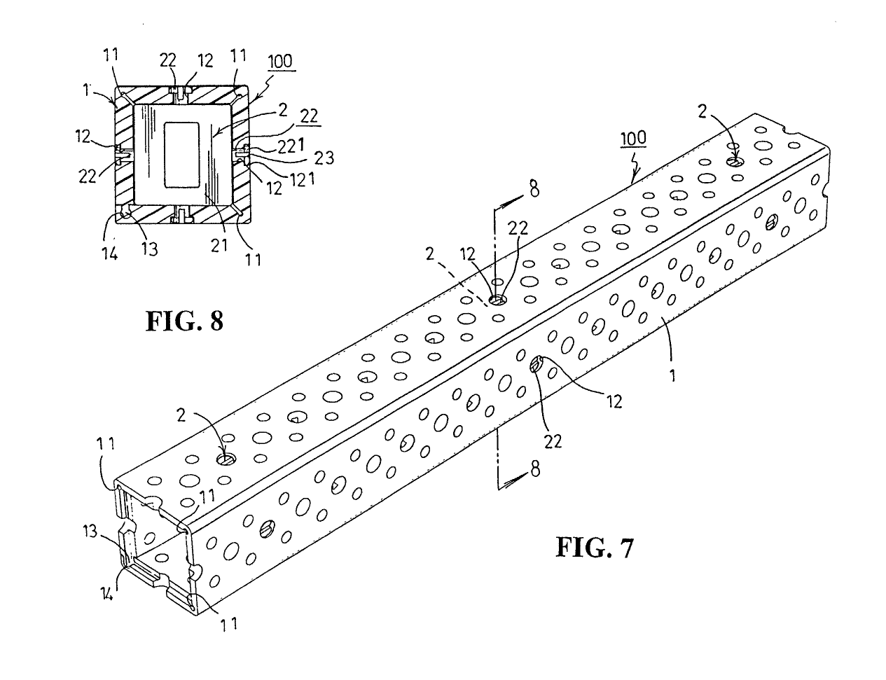

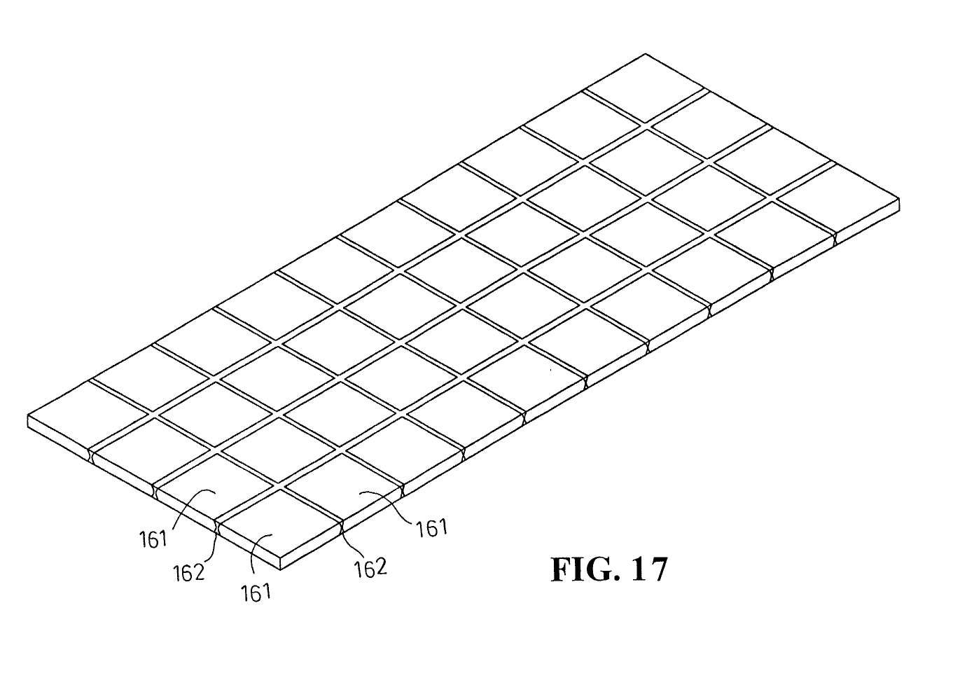

Referring to FIGS. 1 to 17, there is shown a base material so having a board like frame comprising a board body having a board surface. A plurality of recessed grooves are provided on the board body. Thus, the board body is foldable by means of the recessed grooves into a circular shaped cross-sectional sealed frame, a parallelogram cross-sectional sealed frame or other polygonal cross-sectional sealed frame or “C”-shaped cross-sectional or “L”-shaped cross-sectional opened frame.

In accordance with the present invention, the base material 100 can be made from plastic, paperboard, thin metal board, etc. The board body of the base material 100 is provided with a plurality of holes 12 arranged in a matrix arrangement. Thus, the individual lateral side walk of the board body are securely fastened by a plurality of positioning blocks 2 and formed into a stable frame body. If the base materials 100 are connected and are in a planar shape, a larger surface area of a board surface is formed, which can be a wall surface, a cupboard surface, or a table surface, etc.

In accordance with the present invention, the recessed grooves 11 include slot, score, continuous punched holes, elastic laminated layer, etc. formed on the board body1. The board body1 can be folded along the recessed grooves 11 and formed into frame of cross-sectional shape.

In accordance with the present invention, the base material 100 can be rolled up (as shown in FIG. 6) and placed or cut into plate-like structure of a fixed length to facilitate transportation.

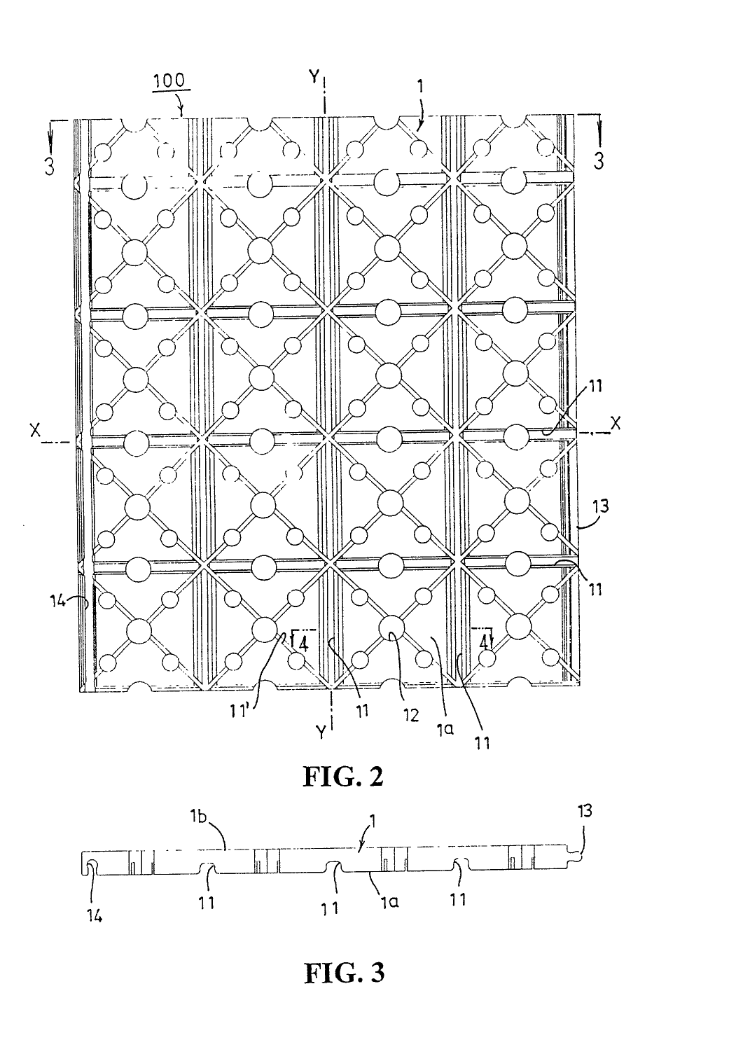

Referring to FIGS. 1 and 2, the base material 100 consists of a board body 1 and the inner board surface parallel to the Y-Y-axis and X-X-axis is provided with a plurality of recesses to form recessed grooves 11 such that the board body 1 can be folded along the recessed groove 11, depending on the required shape for the board body 1, or the board body can be cut or torn along the recessed grooves to provide appropriate size for the board body 1.

As shown in FIGS. 1 or 2, the recessed grooves on the inner lateral board surface la are slots, scored line, continuous punched holes, etc to define a slanting recessed groove 11 for slanting folding of the board body 1.

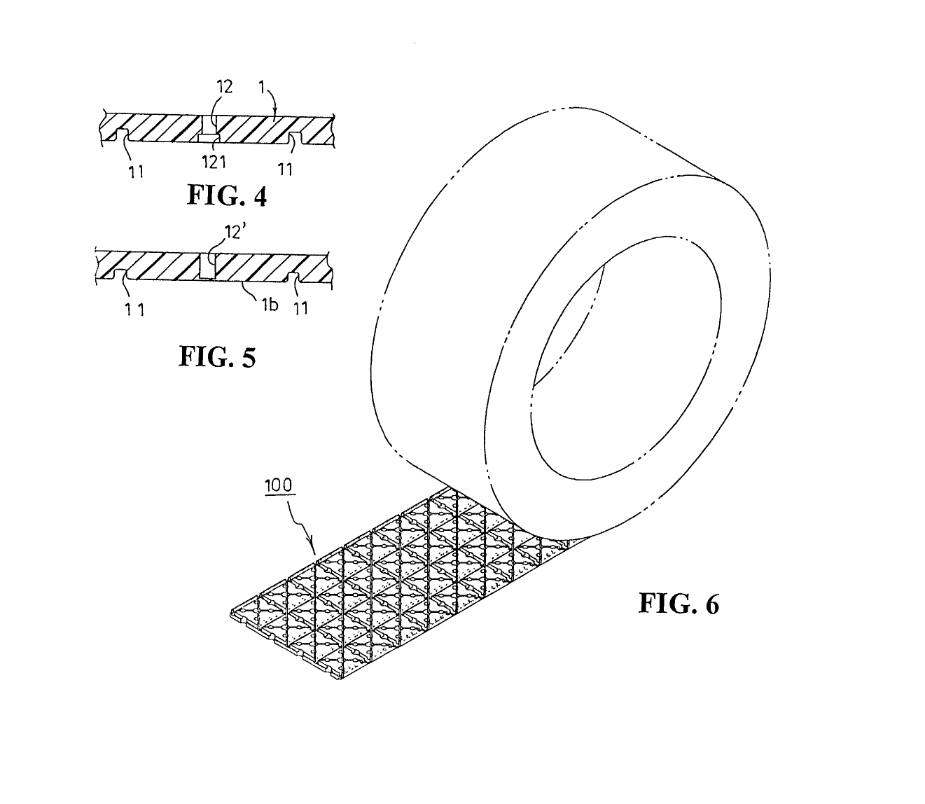

As shown in FIGS. 2 and 4, the board surface of the board body 1 is provided with a plurality of positioning holes 12 which are arranged in a matrix arrangement. The positioning hole 12 has an extended recessed hole section 121 for hooking onto the fastening peg 22 of a first positioning block 2. The positioning hole 12′ may not be a through recessed hole (see FIG. 5) such that the external board surface 1b of the board body 1 forms a flat board surface. In mounting, further positioning holes 12′ can be made so as to fasten onto the fastening peg 22 of the positioning block. Thus, the flat board surface can be made into and used as a table top surface, wall surface or cupboard surface, etc.

The two lateral sides of the base material have a first and a second fastening sections 13, 14 which can be mutually mounted to each other. The first fastening section 13 has a protruded section and the second fastening section 14 is a fastening recess. The two fastening sections 13, 14 are correspondingly fastened to each other so that the board body 1 is formed into a sealed cross-section such as, for instance, a rectangular shaped, a triangular shaped, or a hexagonal shaped frame. The first and second fastening sections 13, 14 can be modified into other shapes of corresponding protruded section and recess.

Referring to FIGS. 1, 2, 7, and 8, the inner side board surface la of the board body 1 is mounted in parallel with three vertical recesses (i.e., recessed grooves 11). The board body 1 can be folded along the recessed grooves to form a rectangular shaped cross-section and the first and second fastening sections 13, 14 at the two lateral sides of the board body 1 can be fastened to each other to form a rectangular cross-section of a stable frame.

When the base material 100 is formed into a hollow frame body, a plurality of positioning blocks 2 are provided to the frame body to enhance the rigidity of the frame structure, as shown in FIG. 8. The positioning block 2 has a body 21 and the body 21 is engageable with the hollow frame structure formed from the board body 1. The lateral side end face of the body 21 is provided radially at least a fastening peg 22 such that the fastening pegs 22 are correspondingly fastened with the positioning boles at the lateral side wall of the individual frame structure so as to stabilize the frame structure.

The fastening peg 22 is radially provided with a slot 23 such that the two lateral sides of the fastening peg 22 are resiliently retracted inwardly to facilitate the fastening peg mounted at the positioning holes 12. The end terminal of the fastening peg 22 is formed into an extended head section 221 so as to fasten at the external edge of the positioning hole 12 or at the extended hole portion 121.

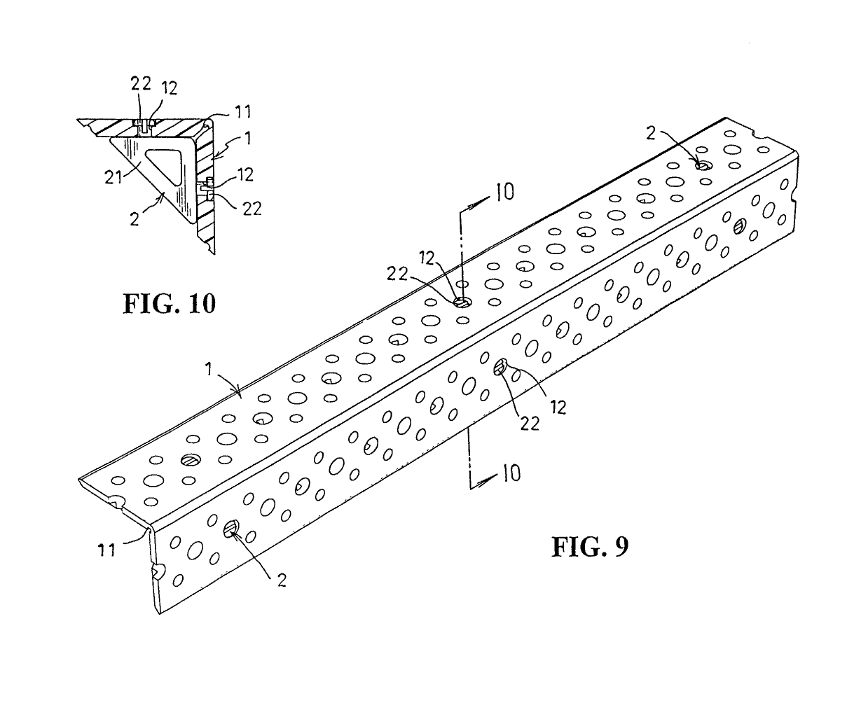

As shown in FIGS. 9 and 10, the board body 1 of the base material 1 can be appropriately cut such that the board body 1 has only one vertical recessed groove structure 11. The board body 1 can be folded along the recesses groove 11 and is formed into an L-shaped structure and the positioning blocks 2 at the two lateral ides of the L-shaped structure are fastened so as to stabilize the individual lateral wall, and a stable L-shaped frame body is obtained.

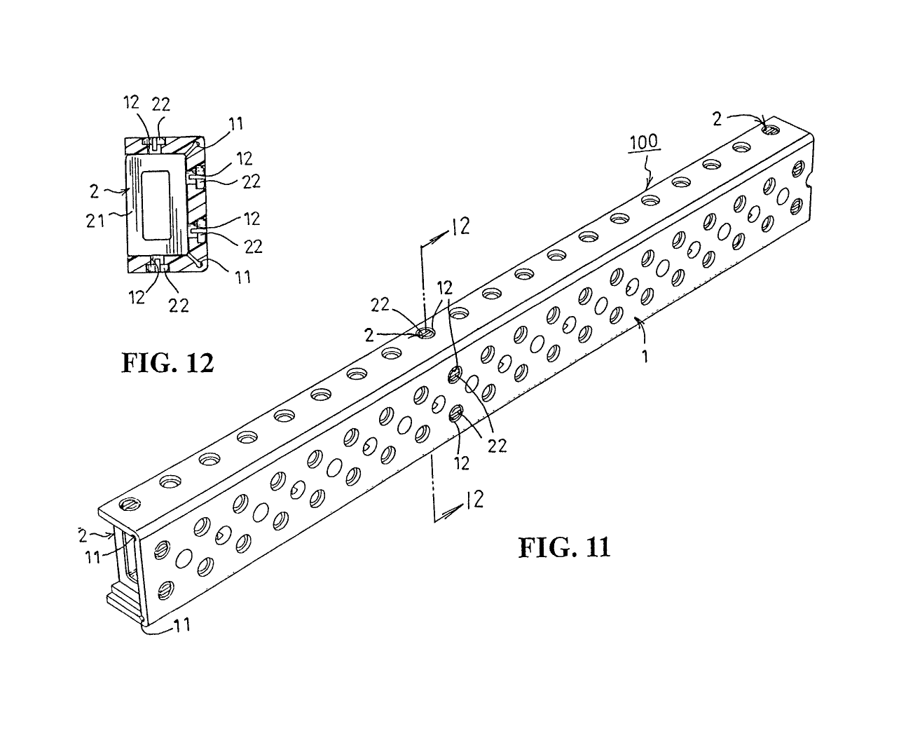

Referring to FIGS. 11 and 12, the board body 1 of the base material 100 can be cut so that the board body 1 is provided with two vertical grooves structure 11. The board body 11 can be folded along the two recessed grooves 11 to form a “C”-shaped structure are provided with a plurality of positioning blocks 2 so as to stabilize the individual lateral wall to form into a stable “C”-shaped opened frame body.

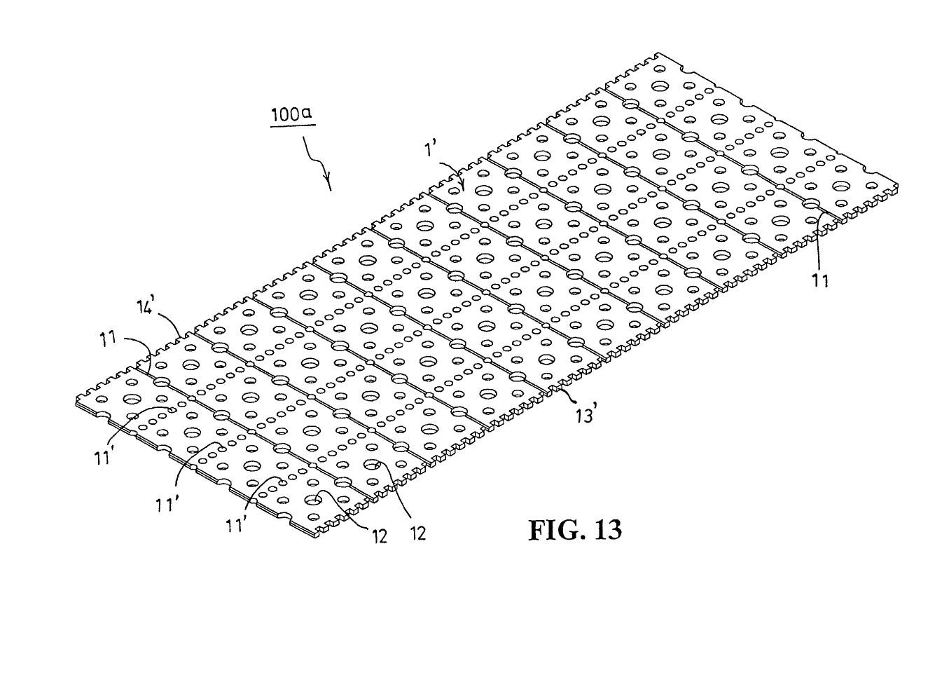

Referring to FIG. 13, the recessed groove on the board body 1 of the base material 100 can be replaced with a plurality of through holes 11 or scored line 11. The recessed grooves 11 or 11′ can be folded or torn. The first and second fastening sections 13, 14 of the two lateral sides of the board body 1 can be formed into alternately arranged zigzag teeth structure to allow planar connection so as to form a flat body. Thus, a board surface of a large surface area is obtained.

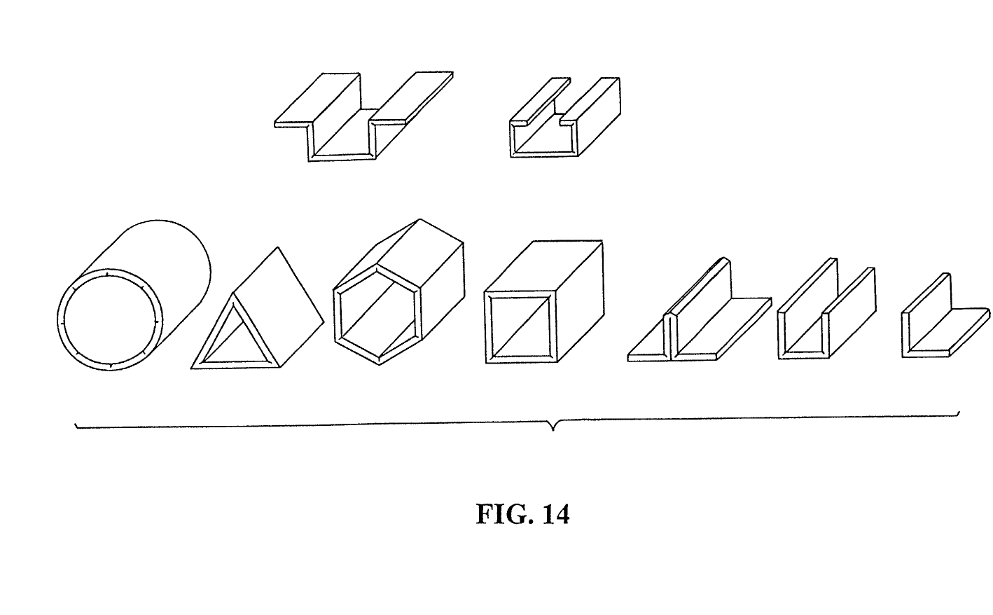

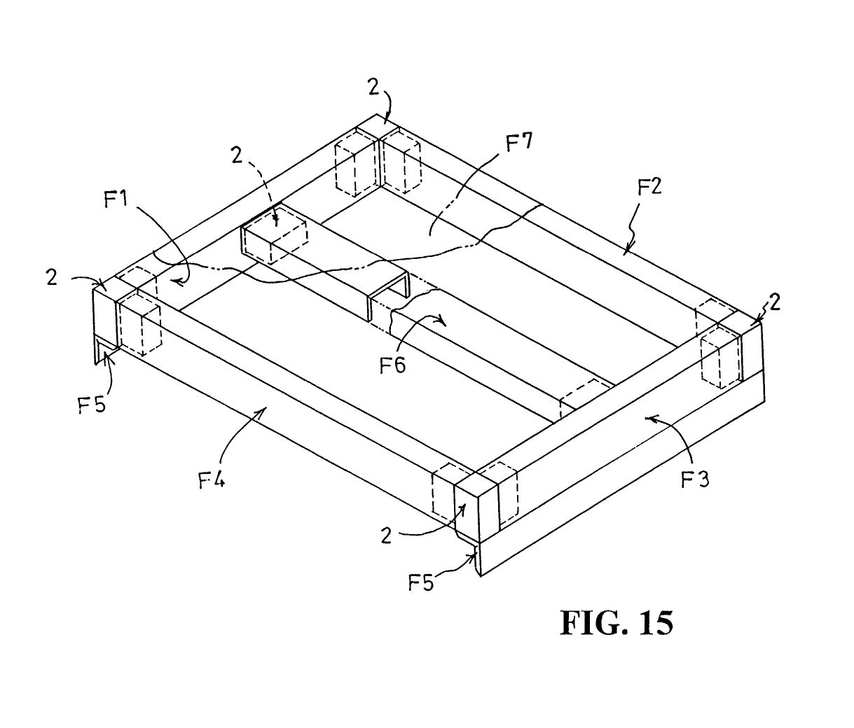

As shown in FIGS. 14 and 15, the two ends of the shaped positioning block 2 are respectively fastened to the lateral end of the rectangular frames F1, F2, F3, F4, such that the four rectangular frames F1, F2, F3, F4 are formed integrally into one frame body and the bottom edges of the rectangular frame F1, F3 are individually connected to an L-shaped frame body F5 with double-sided adhesive tapes, or pegs etc. and the two L-shaped frame body F5 are closely mounted onto the wall. A positioning block is used to mount the rectangular frames F1, F3 and the arch-shaped frame body F6 so as to stably connect the arch-shaped frame body F6 to locate between two rectangular frames F1, F3. At this instance, on the body formed by the frames F1, F2, F3, and F4 and the arch-shaped frame body F6 is mounted a panel F7, and between two corresponding wall surfaced, a table top surface, a display platform, or a table top surface of a display platform is formed. Based on requirement, the invention can be made into a table, cupboard, or wall surface.

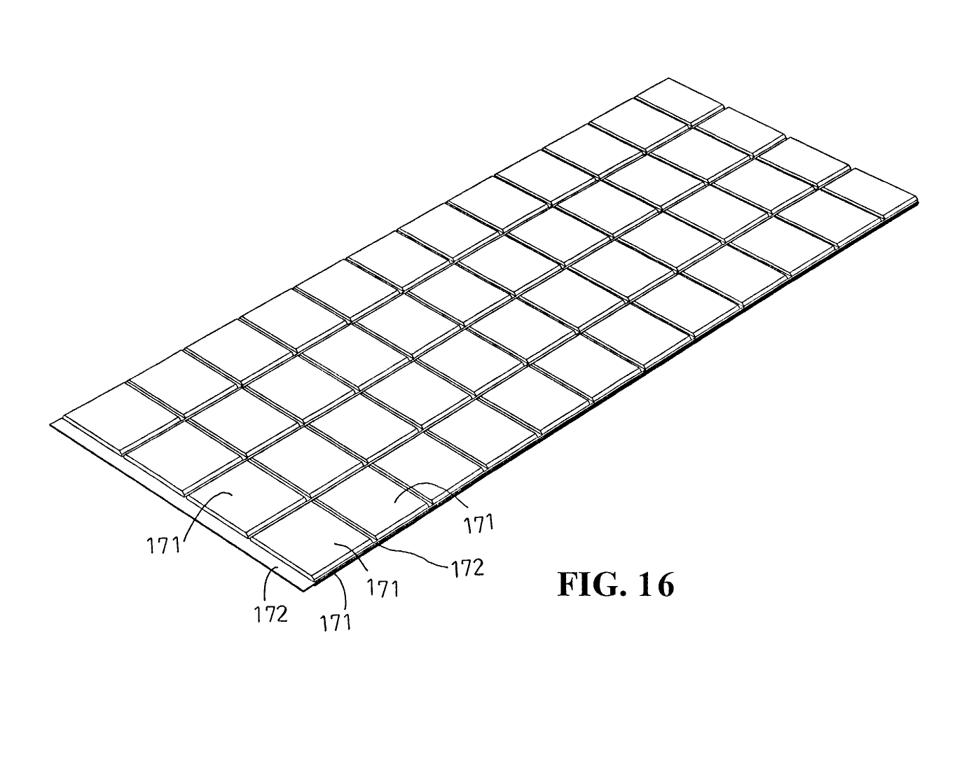

As shown in FIG. 16, the base material of the frame can be made from a hard material 16, and the recessed groove 162 is formed from soft material or elastic material as shown in FIG. 19. A thin or fabric central laminated layer 172 is formed between two corresponding base material 171.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a board-like frame comprising a board body having board surface provided with a plurality of vertical recessed grooves allowing the board body to bend into circular shaped, polygonal shaped, rectangular shaped, triangular shaped, U-shaped, or L-shaped cross-sectional frame structure.

2. The structure of a board-like frame as set forth in claim 1, wherein the board body is rolled to form a rolled structure along the recessed groove.

3. The structure of a board-like frame as set forth in claim 1, wherein the recessed groove is a slot, a score, continuous punched holes, a central laminated layer, or a soft media.

4. The structure of a board-like frame as set forth in claim 1, wherein the board surface is provided with a plurality of positioning holes for mounting a corresponding positioning block to stabilize the frame.

5. The structure of a board-like frame as set forth in claim 1, wherein the two lateral sides of the board body are formed into a first and a second fastening sections.

6. The structure of a board-like frame as set forth in claim 5, wherein the first fastening section is a protruded section, and the second fastening section is a fastening recess such that the first fastening section can mount onto the second fastening section to form into a frame with a sealed cross section.
